(19) United States
(12) Patent Application Publication
(10) Pub. No.: US 2008/0235715 A1
(43) Pub. Date: Sep. 25, 2008

(54) Optical disc apparatus

(75) Inventors: Nobuhiro Washiya, Fujisawa (JP); Kazuhiko Ono, Yokohama (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi-LG Data Storage, Inc., Tokyo (JP)

(21) Appl. No.: 11/901,031

(22) Filed: Sep. 14, 2007

(30) Foreign Application Priority Data
Mar. 19, 2007 (JP) 2007-070855

(51) Int. Cl. G11B 17/03

(52) U.S. Cl. 720/601

(57) ABSTRACT

To eliminate scratches on a disc surface of an optical disc in an emergency eject operation, there is provided an optical disc apparatus including: an emergency eject detector for detecting an emergency eject instruction; a rotation speed detector for producing a signal corresponding to the rotation speed of the optical disc; and a logical circuit unit which is operated by a first signal from the emergency eject detector and a second signal from the rotation speed detector, and when the second output signal is not more than a reference level, produces a third signal so as to input a control signal for instructing stop of the actuator control into an actuator controller. After detection of the emergency eject instruction, the apparatus performs the actuator control without producing the third signal until the rotation speed is not more than a predetermined value. Thus the objective lens is made in a focus control state or in a saving state in which the objective lens is separated from the disc surface.

### CLAIM OF PRIORITY

The present application claims priority from Japanese application serial No. P2007-070855, filed on Mar. 19, 2007, the content of which is hereby incorporated by reference into this application.

### BACKGROUND OF THE INVENTION

1. Technical Field of the Invention

The present invention relates to an optical disc apparatus, and more particularly a configuration for performing an emergency eject operation.

2. Description of the Related Art

An example of a technology related to the present invention may be found in a patent document, such as JP-A No. 182905/2005. In JP-A No. 182905/2005, there is described a technology for reducing the time until a disc is stopped rotating when the disc is ejected from a disc rotation device, by providing a brake device for braking the disc rotation by coming into contact with a rotation part of a rotation drive mechanism for rotating and driving the disc held therein, and by applying a friction force to the rotation part.

### SUMMARY OF THE INVENTION

For example, in a high capacity optical disc such as an optical disc for performing recording and reproduction by a blue laser beam, information is recorded or reproduced in a state in which a distance (an opposing gap) between an end portion of an objective lens of an optical pickup, and a recording surface of an optical disc (hereinafter referred to as a disc surface) is reduced. In such an optical disc apparatus, when an emergency eject operation is performed as a normal disc eject operation is disabled due to a power failure or other failure during recording or reproduction, a protector at the end portion of the objective lens and the disc surface come into contact with each other, for example, due to deflection of the optical disc surface during the rotation of the optical disc, causing scratches on the optical disc surface. The amount of the deflection of the disc surface increases as it approaches the outer peripheral side of the optical disc. Thus, the end portion of the objective lens is likely to come into contact with the disc surface as the position of the objective lens is closer to the outer peripheral side. The scratches caused by the contact are larger and deeper as the optical disc rotates at higher speed.

FIG. 11 is a block diagram showing an example of an optical disc apparatus of a method for inserting and ejecting an optical disc 2 together with a tray 30. The tray 30 is provided with a disc motor 3, an optical pickup 4, a movement guide mechanism (not shown) for moving the optical pickup 4 by guiding in a substantially radial direction of the optical disc 2, and the like. For example, during the recording or reproduction of information on the optical disc 2 in the optical disc apparatus in FIG. 11, when a user performs an emergency eject operation, and more specifically when a user inserts a pin from a small hole 60 to start a switch for emergency eject operation instruction (not shown) inside the apparatus, the tray 30 is moved in the X direction (ejection direction) by an elastic restoring force of a spring (not shown), and is started to be ejected from an apparatus body. At this time, the optical disc 2, which is placed on a turntable 9 fixed to the disc motor 3, moves while rotating with the rotation speed decreasing, in the X direction together with the tray 30. With the movement of the optical disc 2, the outer peripheral side face thereof comes into contact with a brake pad 50 provided on the side of a bottom case 40, and the rotation is stopped by a brake force due to friction based on the contact. After the rotation is stopped, the user manually ejects and moves the optical disc 2. However, as shown in FIG. 12, when the disc surface of the optical disc 2 is deflected before the rotation is stopped, a distance of a disc surface 2a of the optical disc 2 from the protector at the end portion of the objective lens 5 is changed by the rotation. FIG. 12 shows a case in which the disc surface position is changed between a position Q₁ indicated by a solid line and a position Q₂ indicated by a dotted line, due to the surface deflection. The distance of the disc surface 2a from the protector at the end portion of the objective lens 5 is changed from d in the position Q₁ to zero in the position Q₂, and the protector comes into contact with the disc surface. When the information is recorded or reproduced on the optical disc 2 without the emergency eject operation being performed, the position of the objective lens 5 is controlled so that, for example, the distance d is maintained also in the position Q₂.

In the technology described in JP-A No. 182905/2005, the protector of the objective lens and the disc surface could possibly come into contact with each other, when an emergency eject operation is performed and the disc surface is largely deflected until the rotation of the disc is stopped by the brake device.

In view of the circumstances of the related art as described above, it is desirable for the emergency eject operation in the optical disc apparatus to prevent the objective lens or the protector of the objective lens from coming into contact with the disc surface until the rotation of the optical disc is stopped or almost stopped, and to eliminate scratches on the disc surface.

The present invention aims to solve the above described problem and to provide an optical disc apparatus with solid reliability.

The present invention is a technology that can solve the above described problem and achieve the above described object.

That is, in the present invention, there is provided an optical disc apparatus including: an emergency eject detector for detecting an emergency eject operation instruction; a rotation speed detector for producing and outputting a signal corresponding to the rotation speed of an optical disc or disc motor; and a logical circuit unit which is operated based on a first signal output from the emergency eject detector as well as on a second signal output from the rotation speed detector, and when the second signal is not more than a reference level, the logical circuit unit producing a third signal to cause a control signal (mute signal) for instructing the stop of the actuator control of an objective lens, to be input to an actuator controller. After detection of the emergency eject operation instruction, the optical disc apparatus performs the actuator control as a state in which the third signal is not output from the logical circuit unit, until the rotation speed of the optical disc is not more than the predetermined value. With this configuration, the objective lens is made in a focus control state or in a saving state in which the objective lens is separated from the disc surface by a distance greater than the amount of surface deflection. The actuator control for making the objective lens in the saving state is started at a time when the level of an RF signal from the reflected laser beam from the optical disc, is not more than a reference value.

### BRIEF DESCRIPTION OF THE DRAWINGS

FIG. 1 is a block diagram of an optical disc apparatus as a first embodiment of the present invention;

FIG. 2 is a diagram illustrating the configuration of an optical pickup in the optical disc apparatus in FIG. 1;

FIG. 3 is a diagram showing the operation states of the respective units in an emergency eject operation in the optical disc apparatus in FIG. 1;

FIG. 4 is a flowchart of the emergency eject operation in the optical disc apparatus in FIG. 1;

FIG. 5 is a block diagram of an optical disc apparatus as a second embodiment of the present invention;

FIG. 6 is a diagram showing the operation states of the respective units in an emergency eject operation in the optical disc apparatus in FIG. 5;

FIG. 7 is a flowchart of the emergency eject operation in the optical disc apparatus in FIG. 5;

FIG. 8 is a block diagram of an optical disc apparatus as a third embodiment of the present invention;

FIG. 9 is a diagram showing the operation states of the respective units in an emergency eject operation in the optical disc apparatus in FIG. 8;

FIG. 10 is a flowchart of the emergency eject operation in the optical disc apparatus in FIG. 8;

FIG. 11 is a block diagram showing an example of an optical disc apparatus, which illustrates a problem of the present invention; and

FIG. 12 is a diagram of a key section in the optical disc apparatus, which illustrates the problem of the present invention.

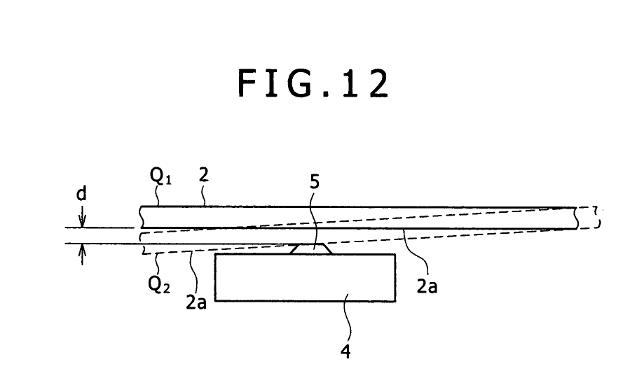

### DETAILED DESCRIPTION OF THE PREFERRED EMBODIMENT

Hereinafter preferred embodiments of the present invention will be described with reference to accompanying drawings.

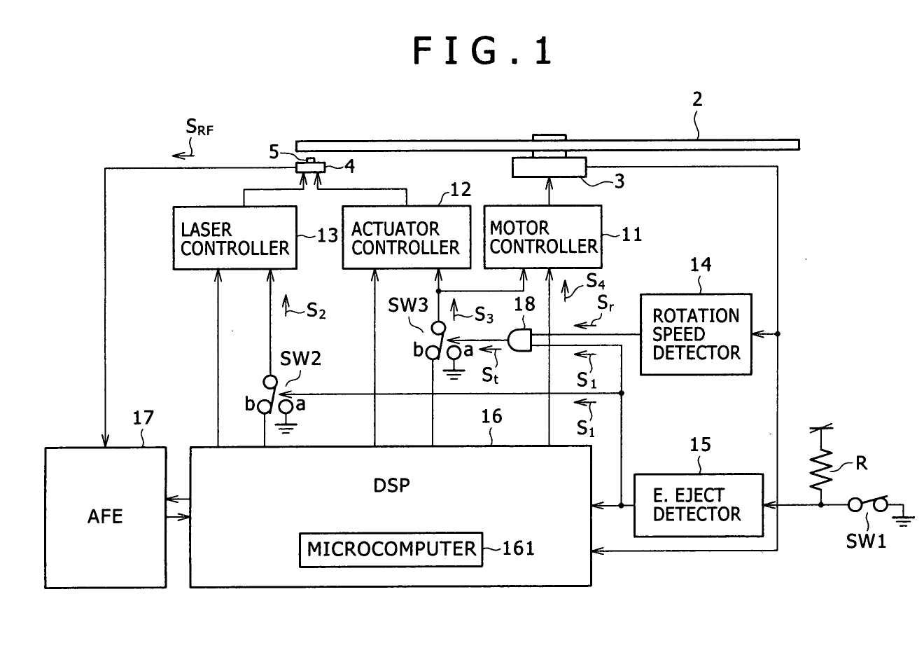

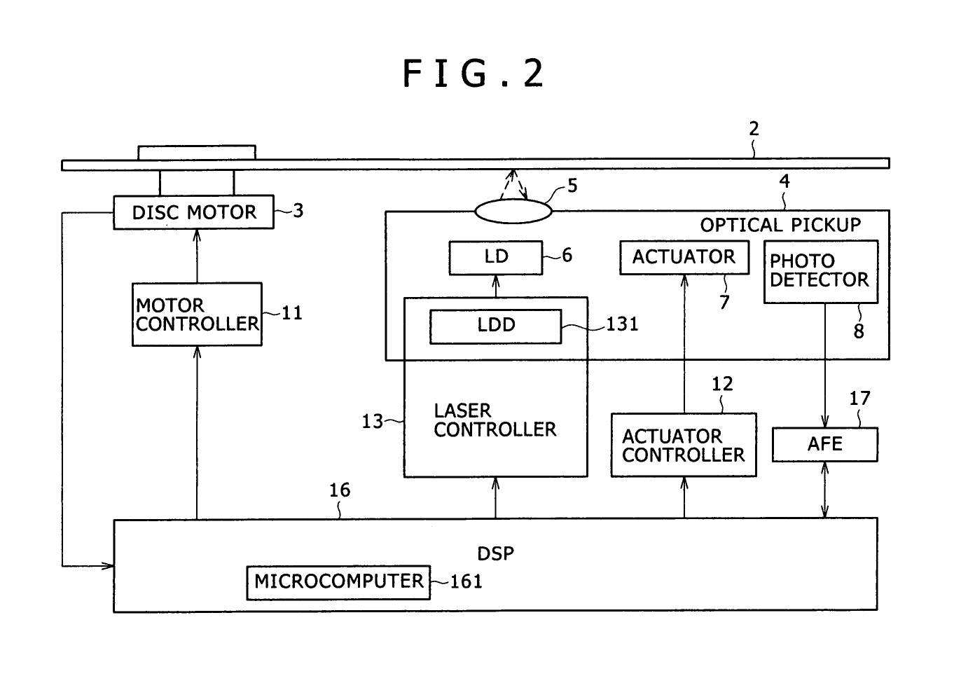

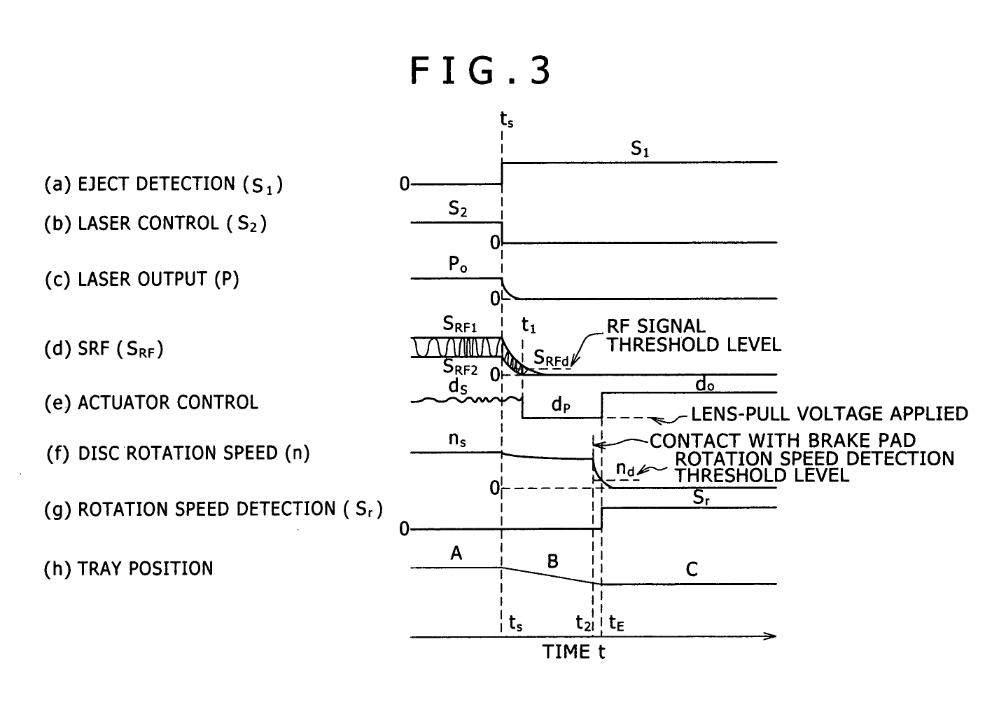

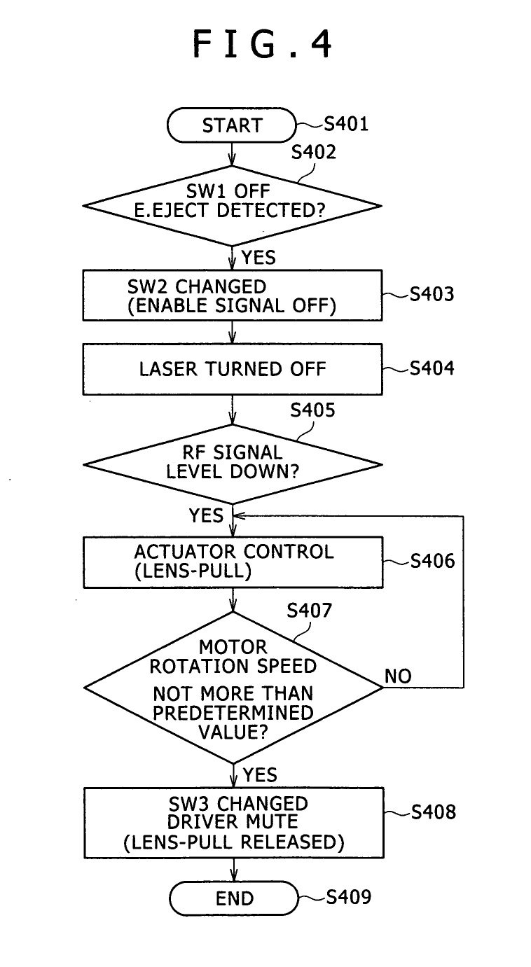

FIGS. 1 to 4 are diagrams illustrating a first embodiment of the present invention. FIG. 1 is a block diagram of an optical disc apparatus as a first embodiment of the present invention. FIG. 2 is a diagram illustrating the configuration of an optical pickup in the optical disc apparatus in FIG. 1. FIG. 3 is a diagram showing the operation states of the respective units in an emergency eject operation in the optical disc apparatus in FIG. 1. FIG. 4 is a flowchart of the emergency eject operation in the optical disc apparatus in FIG. 1. The first embodiment exemplifies the case in which, in the emergency eject operation, an objective lens is saved apart from a disc surface of the optical disc as an actuator control, and the saving state is released when the rotation speed of the optical disc is sufficiently reduced by friction of a brake pad.

In FIG. 1, reference numeral 2 denotes an optical disc. Reference numeral 3 denotes a disc motor for rotating and driving the optical disc 2. Reference numeral 4 denotes an optical pickup. Reference numeral 5 denotes an objective lens. Reference numeral 11 denotes a motor controller for rotating and driving the disc motor 3 while controlling the rotation state. Reference numeral 12 denotes an actuator controller for controlling an actuator in the optical pickup 4 to make the objective lens 5 in a focus control state or in a saving state in which the objective lens 5 is separated from a disc surface (a surface opposed to the objective lens 5) of the optical disc 2. Reference numeral 13 denotes a laser controller for controlling the drive of a laser diode for generating a laser beam in the optical pickup 4. Reference numeral 14 denotes a rotation speed detector having a configuration for detecting the rotation speed of the optical disc 2 or disc motor 3, for example, based on a method such as the back electromotive force of a stator coil of an FG (Frequency Generator) or of the disc motor 3, and for not outputting a signal Sᵣ as a second signal when the detected rotation speed exceeds a predetermined reference value, while producing and outputting the signal Sᵣ as the second signal when the detected rotation speed is not more than the reference value. Reference numeral 15 denotes an emergency eject detector for detecting that an emergency eject operation to the optical disc 2 is instructed, and producing and outputting a signal (hereinafter referred to as a first signal) S₁ as a first signal. Reference numeral 16 denotes a DSP (Digital Signal Processor) as a controller for controlling the entire optical disc apparatus. Reference numeral 161 denotes a microcomputer incorporated in the DSP 16. Reference numeral 17 denotes an analog front end (hereinafter referred to as an AFE) for amplifying an RF (Radio Frequency) signal reproduced by the optical pickup 4 based on the reflected laser beam from the optical disc 2, and shaping the waveform of the RF signal. Reference numeral 18 denotes a logical circuit unit for producing and outputting a signal (hereinafter referred to as a third signal) Sₜ as a third signal to cause a control signal for instructing the stop of the actuator control, namely, a mute signal S₃, to be supplied to the actuator controller 12, based on the first signal S₁ output from the emergency eject detector and on a signal (hereinafter referred to as a second signal) Sᵣ as a second signal output from the rotation speed detector 14.

Further, reference symbol SW1 denotes an emergency eject operation instruction switch for instructing an emergency eject operation by an emergency eject operation of the user. Reference symbol SW2 denotes a switch provided between the DSP 16 and the laser controller 13, to turn on/off the supply of a control signal for turning on the laser output of the laser diode, namely, an enable signal S₂, from the DSP 16 to the laser controller 13. Reference symbol SW3 denotes a switch provided between the DSP 16 and the actuator controller 12 to turn on/off the supply of the mute signal S₃ for instructing the stop of the actuator control, from the DSP 16 or ground to the actuator controller 12. Reference symbol R denotes a pull-up resistance to make the input level of the emergency eject detector 15 high, when the switch SW1 is in an off state (open state). Each of the switches SW1, SW2, SW3 is constituted by a circuit switch using a semiconductor, and the like. The logical circuit unit 18 is configured not to produce the third signal Sₜ when the second signal Sᵣ is not input and only the first signal S₁ is input, and to produce and output the third signal Sₜ when the first signal S₁ and second signal Sᵣ are both input. The switch SW1 performs on/off operation by the emergency eject operation of the user. The switch SW2 is controlled on/off by the first signal S₁ output from the emergency eject detector 15. The switch SW3 is controlled on/off by the third signal Sₜ output from the logical circuit unit 18.

Further, in FIG. 2, reference numeral 6 denotes a laser diode provided in the optical pickup 4. Reference numeral 7 denotes an actuator also provided therein. Reference numeral 8 denotes a photo detector provided in the optical pickup 4, for receiving the reflected laser beam from a recording surface of the optical disc 2 through the objective lens 5, converting into an electrical signal, and outputting the electrical signal. Reference numeral 131 denotes a laser drive circuit provided in the laser controller 13 to drive the laser diode. The other reference numerals are the same as those in FIG. 1.

In the configurations shown in FIGS. 1 and 2, the switch SW1 is turned off (to the open state) by the emergency eject operation of the user. The emergency eject detector 15 performs the detection of an emergency eject operation instruction when the switch SW1 is turned off, and outputs the signal S₁ as the first signal.

In the switch SW2, the connection to a terminal b side is turned on (to the closed state) to supply the control signal, namely, the enable signal S₂, for the laser drive circuit 131 to drive the laser diode 6 so that the laser output is turned on, from the DSP 16 to the laser controller 13. On the other hand, the connection to a terminal a side is turned on (to the closed state) to stop the supply of the enable signal S₂ from the DSP 16 to the laser controller 13. As a result, the laser drive circuit 131 does not drive the laser diode 6, and the laser output is turned off. The first signal S₁ output from the emergency eject detector 15 switches the connection state of the switch SW2 so that the connection to the terminal b side is turned off (to the open state) and the connection to the terminal a side is turned on (to the closed state). In this way, the supply of the enable signal S₂ from the DSP 16 to the laser controller 13 is stopped (turned off).

In the switch SW3, the connection of the switch SW3 to the terminal a side is turned off (to the closed state) to turn on the supply of the control signal for instructing the stop of the actuator control, namely, the mute signal S₃, to the actuator controller 12. On the other hand, the connection to the terminal b side is turned on (to the closed state) to turn on the supply of the control signal for instructing the actuator control of the objective lens 5, namely, the control signal for instructing that the objective lens 5 is made in a saving state, from the DSP 16 to the actuator controller 12. The actuator control for making the objective lens 5 in the saving state is started at a time when the level of the RF signal S_{RF} from the reflected laser beam from the optical disc 2 is not more than a predetermined reference value. In the saving state, the objective lens is moved so that the end portion or protector thereof is located apart from the disc surface of the optical disc 2 by a distance greater than the amount of surface deflection of the optical disc 2. For this reason, the objective lens does not come into contact with the disc surface. Further, when the connection to the terminal b side is turned off (to the open state), the mute signal S₃ is supplied from the ground to the actuator controller 12. Thus the saving state of the objective lens 5 is released. The third signal Sₜ output from the logical circuit unit 18 switches the connection state of the switch SW3 so that the connection to the terminal a side is turned on (to the closed state) and the connection to the terminal b side is turned off (to the open state). In this way, the mute signal S₃ is supplied from the ground to the actuator controller 12.

In the above described configuration, when the user performs the emergency eject operation during when the optical disc apparatus performs a recording or reproduction operation on the optical disc 2, the switch SW1 is turned off (to the open state). The emergency eject detector 15 performs the detection of an emergency eject operation instruction, and outputs the first signal S₁. The first signal S₁ is input to the switch SW2, the logical circuit unit 18, and the DSP 16. In the switch SW2, the connection to the terminal a side is turned on (to the closed state) by the first signal S₁ to stop the supply of the enable signal S₂ from the DSP 16 to the laser controller 13. As a result, the laser drive circuit 131 stops driving the laser diode 6, and the laser output is turned off. As the laser output is turned off, the level of the RF signal S_{RF} is gradually reduced to zero. At this time, the microcomputer 161 of the DSP 16 determines the level of the RF signal S_{RF}. At the time when the level is not more than a predetermined reference value, the microcomputer 161 causes the DSP 16 to produce therein the control signal for instructing the actuator controller 12 to perform the actuator control to make the objective lens 5 in the saving state. The control signal is input from the DSP 16 to the actuator controller 12. Based on this, the objective lens 5 is moved to a saving position and is made in the saving state.

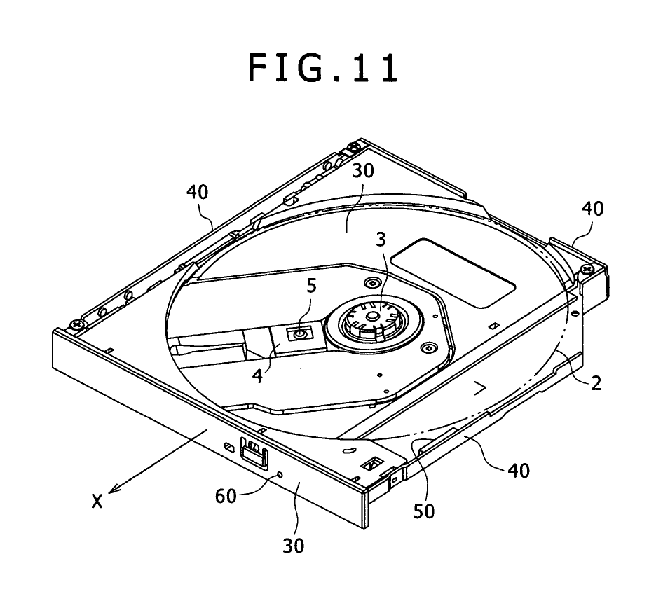

Further, in response to the input of the first signal S₁, the DSP 16 produces a control signal S₄ for instructing the drive stop of the disc motor 3, and outputs the control signal S₄ to the motor controller 11. The drive of the disc motor 3 is stopped in this way, so that the rotation speed of the optical disc 2 or the rotation speed of the disc motor 3 is gradually reduced as the time passes. Further, as the user performs the emergency eject operation, similarly to the case shown in FIG. 11, the optical disc 2 is moved in the direction of being ejected from the apparatus together with the tray, in a state in which the optical disc 2 is placed on the turntable fixed to the disc motor 3, while the rotation speed is reduced. When the outer peripheral side face of the optical disc 2 comes into contact with the brake pad 50 inside the apparatus, the rotation speed is rapidly reduced to zero, namely, the rotation is stopped. In the ejection movement of the optical disc 2, the objective lens 5 is already in the saving state by the actuator control. For this reason, the objective lens 5 does not come into contact with the disc surface of the optical disc 2 which is still rotating although the rotation speed is reduced. The rotation speed detector 14 detects the rotation speed of the optical disc 2 in such a state or the rotation speed of the optical disc 3, for example, as a voltage signal level, and compares the voltage signal level of the detected rotation speed with a predetermined reference value. As a result of the comparison, when the voltage signal level exceeds the reference value, the rotation speed detector 14 does not output the second signal Sᵣ. The second signal Sᵣ is input to the logical circuit unit 18, similarly to the first signal S₁ output from the emergency eject detector 15. On the other hand, when the voltage signal level is not more than the reference value as a result of the comparison, the rotation speed detector 14 outputs the second signal Sᵣ.

The logical circuit unit 18 produces and outputs the third signal Sₜ based on the first signal S₁ and on the second signal Sᵣ. In other words, the logical circuit unit 18 does not produce the third signal Sₜ when the second signal Sᵣ is not output from the rotation speed detector 14 or is zero, namely, the second signal Sᵣ is not input to the logical circuit unit 18. On the other hand, the logical circuit unit 18 produces and outputs the third signal Sₜ when the second signal Sᵣ is output from the rotation speed detector 14 and is input to the logical circuit unit 18. The third signal Sₜ controls the switch SW3 to turn the connection to the terminal a side (to the closed state), and to turn off the connection to the terminal b side (to the open state). In this way, the control signal for instructing the stop of the actuator control, namely, the control signal (mute signal) S₃ for instructing the release of the saving state of the objective lens 5 is supplied from the ground to the actuator controller 12. Based on the control signal (mute signal) S₃, the actuator controller 12 stops the actuator control and releases the saving state of the objective lens 5. At this time, the optical disc 2 has been almost in a rotation stop state. Thus, there could be no scratch occurring on the disc surface, even if the saving state of the objective lens 5 is released and the end portion or protector of the objective lens 5 comes into contact with the disc surface. After the rotation is stopped, the optical disc 2 is ejected and moved outside the apparatus together with the tray by manual operation of the user.

FIG. 3 is a diagram showing the operation states of the respective units in the emergency eject operation in the optical disc apparatus in FIG. 1. The abscissa is a time axis.

In FIG. 3, (a) shows the level change state of the first signal S₁ output from the emergency eject detector 15, when the user performs an emergency eject operation and the switch SW1 is turned off (to an open state) at the time point tₛ; (b) shows the level change state of the enable signal S₂ supplied from the DSP 16 to the laser controller 13; (c) shows the level change state of the laser beam (laser output) P output from the laser diode 6; (d) shows the change state of the RF signal S_{RF}; (e) shows the change state of the focus direction position of the objective lens 5 by the actuator control; (f) shows the change state of the rotation speed n of the optical disc 2; (g) shows the change state of the second signal Sᵣ output by the rotation speed detector 14; and (h) shows the change state of the tray position, respectively.

In (d), the RF signal S_{RF} is in a steady-state level range between a maximum value S_{RF1} and a minimum value S_{RF2} until the time point tₛ in which the switch SW1 is turned off (to the open state), because the optical disc apparatus is in a recording or reproduction state with the laser output P being the value of a steady-state level P₀. After the time point tₛ, the level (the level of the RF signal S_{RF}) is reduced as the level of the laser output P is reduced. The level of the RF signal S_{RF} is determined by comparing with a predetermined reference value (threshold level) S_{RFd} by the microcomputer 161 of the DSP 16. As a result of the determination, at a time point t₁ in which the level is not more than the reference value S_{RFd}, as shown in (e), the microcomputer 161 switches the actuator control of the objective lens 5 from the focus control state to a lens saving state, namely, the state in which a direct current lens-pull voltage is applied. The rotation speed of the optical disc 2 in (f) is gradually reduced after the time point tₛ. During this time, as indicated by a characteristic line B in (h), the tray position is moved to a position in which the outer peripheral side face of the optical disc 2 comes into contact with the brake pad. The optical disc 2 is moved by the tray, and the outer peripheral side face thereof comes into contact with the brake pad at a time point t₂. After the time point t₂, the rotation speed n of the optical disc 2 is rapidly reduced to zero by friction of the brake pad. The rotation speed n of the optical disc 2 is detected by the rotation speed detector 14, and is compared with a reference value (a rotation speed detection threshold level) n_{d} ((f)). As a result of the comparison, when the rotation speed n is not more than the reference value n_{d}, the second signal Sᵣ is output at a time point t_{E} in which the rotation speed n is not more than the reference value n_{d}. As a result, the second signal Sᵣ and the first signal S₁ output from the emergency eject detector 15 are input to the logical circuit unit 18, and the third signal Sₜ is produced and output therefrom. The third signal Sₜ controls the switch SW3 at the time point t_{E} to cause the control signal (mute signal) S₃ to be supplied from the ground to the actuator controller 12. Based on the control signal (mute signal) S₃, the actuator controller 12 stops the actuator control and releases the saving state of the objective lens 5 ((e)).

FIG. 4 is a flowchart of the emergency eject operation in the optical disc apparatus in FIG. 1.

As shown in FIG. 4, the following steps are performed:

(1) During the recording or reproduction of information on the optical disc 2, the switch SW1 is turned off (to the open state) by manual operation of the user, and the emergency eject operation is started (Step S401).

(2) As the switch SW1 is turned off, the emergency eject detector 15 performs the detection of an emergency eject operation instruction. The microcomputer 161 of the DSP 16 determines whether this was performed, namely, whether the first signal S₁ was output from the emergency eject detector 15 (Step S402).

(3) As a result of the determination, when the first signal S₁ has been output, the first signal S₁ is input to the switch SW2, and switches the connection state of the switch SW2 to turn on the supply of the enable signal S₂ from the DSP 16 to the laser controller 13 (Step S403).

(4) As the supply of the enable signal S₂ to the laser controller 13 is stopped, the laser drive circuit 131 stops the drive of the laser diode 6. Thus the laser output is turned off (the light is turned off) (Step S404).

(5) As the laser output is turned off, the level of the RF signal S_{RF} from the reflected laser beam is gradually reduced to zero. The microcomputer 161 determines whether the level of the RF signal S_{RF}, which is input to the DSP 16 through the AFE 17, is not more than the predetermined reference value (S_{RFd} shown in FIG. 3 (d)) (Step S405).

(6) As a result of the determination in Step S405, when the level of the RF signal S_{RF} is not more than the predetermined reference value, the microcomputer 161 causes the DSP 16 to produce therein the control signal for instructing the actuator controller 12 to perform the actuator control to make the objective lens 5 in the saving state. The control signal is input from the DSP 16 to the actuator controller 12. Based on the control signal, the actuator controller 12 performs the actuator control of the objective lens 5, namely, the actuator controller 12 controls the actuator 7 to save and move the objective lens 5 (as lens-pull operation) (Step S406). In the saving movement, the objective lens 5 is moved to a position in which the end portion or protector thereof is separated from the disc surface of the optical disc 2 by a distance greater than the amount of surface deflection of the optical disc 2.

(7) In response to the input of the first signal S₁, the DSP 16 produces the signal S₄ for instructing the drive stop of the disc motor 3, and outputs to the motor controller 11. When the disc motor 3 is stopped, the rotation speed of the disc motor 3 is gradually reduced, and the rotation speed of the optical disc 2 is also reduced. The optical disc 2 in such a rotation state is ejected and moved by the tray, and the outer peripheral side face thereof is brought into contact with the brake pad 50. The rotation speed of the optical disc 2 is rapidly reduced by friction of the contact, and finally the rotation is stopped. In the ejection movement of the optical disc 2, the objective lens 5 is already located in the saving position by the actuator control. For this reason, the objective lens 5 does not come into contact with the disc surface of the optical disc 2. The rotation speed detector 14 detects the rotation speed of the optical disc 2 in such a state (rotation reduced state after the contact with the brake pad 50) or the rotation speed of the disc motor 3, and determines whether the rotation speed is not more than the predetermined reference value (n_{d} shown in FIG. 3(f)) (Step S407).

(8) As a result of the determination in Step S407, when the rotation speed of the optical disc 2 or disc motor 3 is not more than the predetermined reference value, the rotation speed detector 14 outputs the second signal Sᵣ. As a result, the second signal Sᵣ and the first signal S₁ are input to the logical circuit unit 18. In response to this input, the logical circuit unit 18 produces and outputs the third signal Sₜ. The third signal Sₜ switches the connection state of the switch SW3 to cause the control signal for instructing the stop of the actuator control, namely, the control signal (mute signal) S₃ for instructing the release of the saving state of the objective lens 5, to be supplied from the ground to the actuator controller 12. Based on the control signal (mute signal) S₃, the actuator controller 12 stops the actuator control and releases the saving state of the objective lens 5 (as lens-pull operation) (Step S408).

(9) As a result of the determination in Step S407, when the rotation speed of the optical disc 2 or disc motor 3 exceeds the predetermined reference value, the actuator control is not stopped and the saving state of the objective lens 5 is maintained.

(10) After the release of the saving state of the objective lens 5 in Step S408, the optical disc 2 in a rotation stop state is ejected and moved outside the apparatus together with the tray by manual operation of the user, and then the emergency eject operation ends (Step S409).

According to the above described first embodiment, in the emergency eject operation in the optical disc apparatus, the objective lens is made in the saving state until the rotation of the optical disc is stopped or nearly stopped. For this reason, the objective lens or the protector thereof does not come into contact with the disc surface even if the surface of the optical disc 2 is deflected. This makes it possible to eliminate scratches on the disc surface.

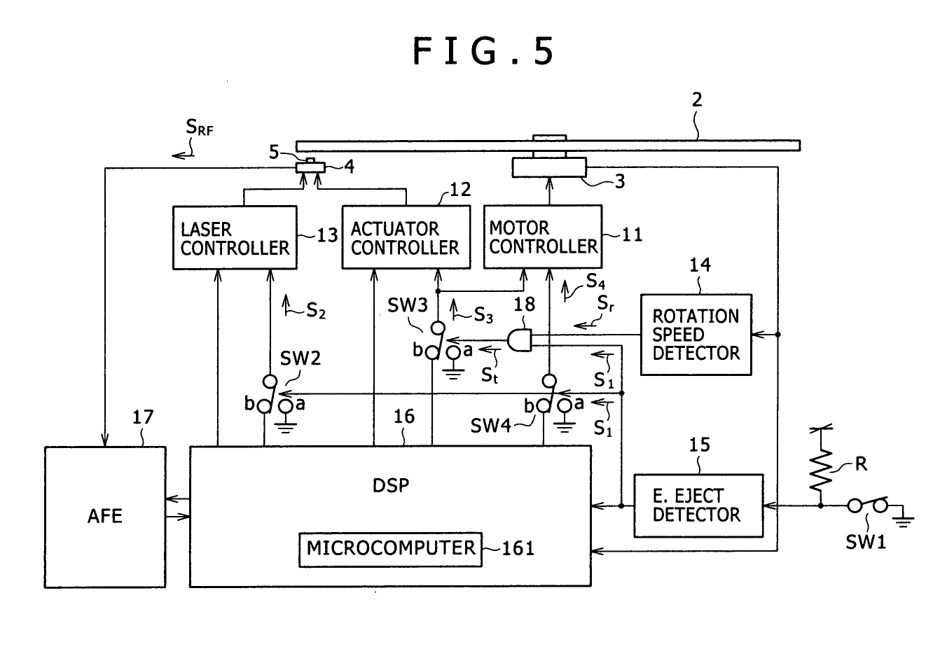

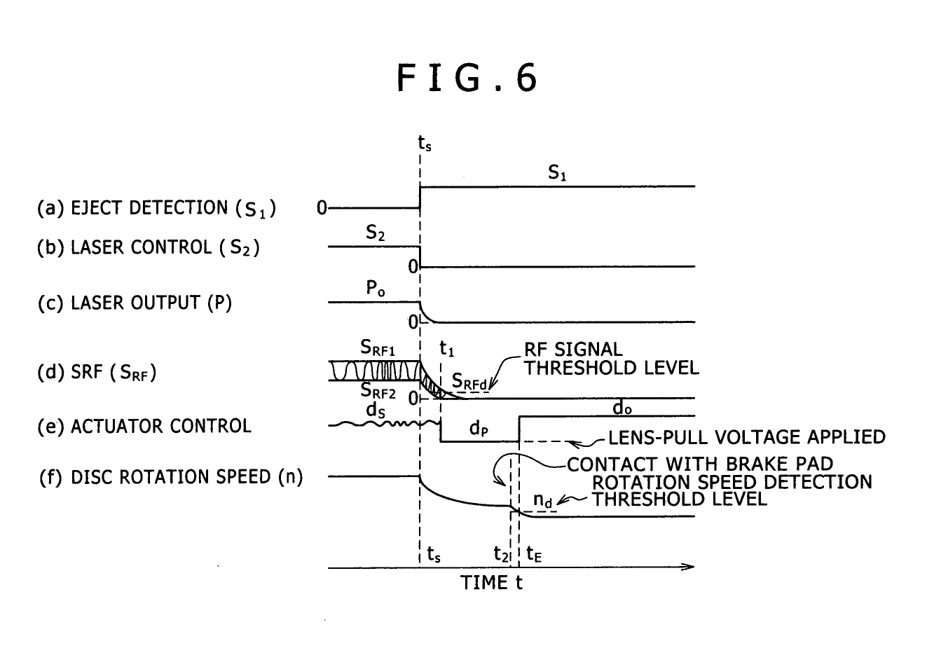

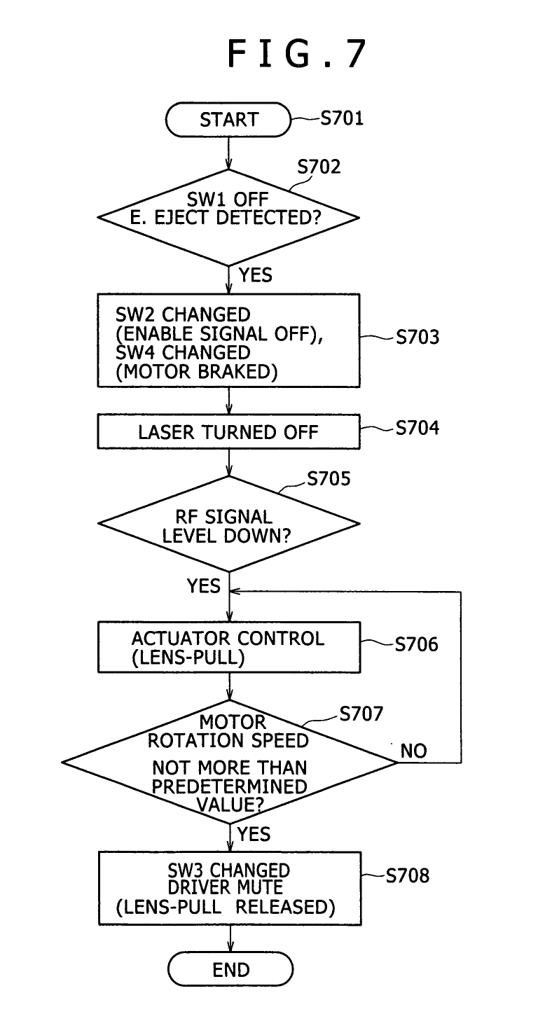

FIGS. 5 to 7 are diagrams illustrating a second embodiment of the present invention. FIG. 5 is a block diagram of an optical disc apparatus as a second embodiment of the present invention. FIG. 6 is a diagram showing the operation states of the respective units in an emergency eject operation in the optical disc apparatus in FIG. 5. FIG. 7 is a flowchart of the emergency eject operation in the optical disc apparatus in FIG. 5. The second embodiment exemplifies the case in which, in the emergency eject operation, the objective lens is made in the saving state in which the objective lens is saved apart from the disc surface of the optical disc as the actuator control, while the rotation speed of the optical disc is reduced by applying a brake force to the disc motor, and the saving state is released when the rotation speed of the optical disc is sufficiently reduced by friction of the brake pad.

In the optical disc apparatus in FIG. 5, the components and the operations are the same as those in the case of the optical disc apparatus in FIG. 1, except a switch SW4. The switch SW4 is provided between the DSP 16 as the controller and the motor controller 11 to switch on/off the supply of the control signal S₄ for instructing the drive stop of the disc motor 3 and the application of a brake force, from the DSP 16 to the motor controller 11. The on/off state of the switch SW4 is controlled based on the first output signal S₁ output from the emergency eject detector 15. In the switch SW4, the connection to the terminal b side is turned on (to the closed state) to cause the control signal S₄ to be supplied from the DSP 16 to the motor controller 11.

In the configuration in FIG. 5, when the user performs an emergency eject operation during when the optical disc apparatus records or reproduces information on the optical disc 2, the switch SW1 is turned off (to the open state). The emergency eject detector 15 performs the detection of an emergency eject operation instruction, and outputs the first signal S₁. The first signal S₁ is input to the switch SW2, the switch SW4, the logical circuit unit 18, and the DSP 16. In the switch SW2, based on the first signal S₁, the connection to the terminal a side is turned on (to the closed state) to stop the supply of the enable signal Sᵣ from the DSP 16 to the laser controller 13. As a result, the laser drive circuit 131 stops the drive of the laser diode 6, and the laser output is turned off. As the laser output is turned off, the level of the RF signal S_{RF} is gradually reduced. At this time, the microcomputer 161 of the DSP 16 determines the level of the RF signal S_{RF}. At the time when the level is not more than a predetermined reference value, the microcomputer 161 causes the DSP 16 to produce therein the control signal for instructing the actuator controller 12 to perform the actuator control to make the objective lens 5 in the saving state. The control signal is input from the DSP 16 to the actuator controller 12, and the objective lens is made in the saving state. In the switch SW4, based on the first signal S₁, the connection to the terminal b side is turned off (to the open state) to turn on the supply of the control signal S₄ for instructing the drive stop of the disc motor 3 and the application of a brake force, from the ground to the motor controller 11. In this way, the rotation speed of the optical disc 2 is reduced in a state in which the drive of the disc motor 3 is stopped and the brake force is applied thereto.

As the drive of the disc motor 3 is stopped, the rotation speed of the optical disc 2 or the rotation speed of the disc motor 3 is gradually reduced. In addition, as the brake force is applied, the reduction of the rotation speed of the disc motor 3 is accelerated. When the user performs the emergency eject operation, the optical disc 2 is moved in the direction of being ejected from the apparatus together with the tray, while the rotation speed is reduced. The rotation speed is rapidly reduced at the position in which the outer circumference of the optical disc 2 comes into contact with the brake pad 50, and finally the rotation is stopped. In the movement of the optical disc 2, the objective lens 5 is already in the saving state by the actuator control. For this reason, the objective lens 5 does not come into contact with the disc surface of the optical disc 2 which is still rotating although the rotation speed is reduced. The rotation speed detector 14 detects the rotation speed of the optical disc 2 in such a state or the rotation speed of the disc motor 3, for example, as a voltage signal level, and compares the voltage signal level of the detected rotation speed with a predetermined reference value. As a result of the comparison, when the voltage signal level exceeds the reference value, the rotation speed detector 14 does not output the second signal Sᵣ. The second signal Sᵣ is input to the logical circuit unit 18, similarly to the first signal S₁ output from the emergency eject detector 15. On the other hand, when the voltage signal level is not more than the reference value as a result of the comparison, the rotation speed detector 14 outputs the second signal Sᵣ.

The logical circuit unit 18 produces and outputs the third signal Sₜ based on the first signal S₁ as well as on the second signal Sᵣ. In other words, the logical circuit unit 18 does not produce the third signal Sₜ when the second signal Sᵣ is not output from the rotation speed detector 14 or is zero, namely, when the second signal Sᵣ is not input to the logical circuit unit 18. On the other hand, the logical circuit unit 18 produces and outputs the third signal Sₜ when the second signal Sᵣ is output from the rotation speed detector 14 and is input to the logical circuit unit 18. The third signal Sₜ controls the switch SW3 to turn on the connection to the terminal a side (to the closed state), and to turn off the connection to the terminal b side (to the open state). In this way, the control signal for instructing the stop of the actuator control, namely, the control signal (mute signal) S₃ for instructing the release of the saving state of the objective lens 5, is supplied from the ground to the actuator controller 12. Based on the control signal (mute signal) S₃, the actuator controller 12 stops the actuator control and releases the saving state of the objective lens 5. At this time, the optical disc 2 has been almost in a rotation stop state. Thus, there could be no scratch occurring on the disc surface, even if the saving state of the objective lens 5 is released and the end portion or protector of the objective lens 5 comes into contact with the disc surface of the optical disc 2. After the rotation is stopped, the optical disc 2 is ejected and moved outside the apparatus together with the tray by manual operation of the user.

FIG. 6 is a diagram showing the operation states of the respective units in the emergency eject operation in the optical disc apparatus in FIG. 5. The abscissa is a time axis.

In FIG. 6, (a) shows the level change state of the first signal S₁ output from the emergency eject detector 15, when the user performs an emergency eject operation and the switch SW1 is turned off (to the open state) at the time point tₛ; (b) shows the level change state of the enable signal S₂ supplied from the DSP 16 to the laser controller 13; (c) shows the level change state of the laser beam (laser output) P output from the laser diode 6; (d) shows the change state of the RF signal S_{RF}; (e) shows the change state of the focus direction position of the objective lens 5 by the actuator control; and (f) shows the change state of the rotation speed n of the optical disc 2, respectively. The change state of the second signal Sᵣ output by the rotation speed detector 14 and the change state of the tray position are the same as those in FIG. 3.

In (d), the RF signal S_{RF} is in a steady-state level range between the maximum value S_{RF1} and the minimum value S_{RF2} until the time point tₛ in which the switch SW1 is turned off (to the open state), because the optical disc apparatus is in a recording or reproduction state with the laser output P being the value of the steady-state level P₀. After the time point tₛ, the level of the RF signal S_{RF} is reduced as the level of the laser output P is reduced. The level of the RF signal S_{RF} is determined by comparing with the predetermined reference value (threshold level) S_{RFd} by the microcomputer 161 of the DSP 16. As a result of the determination, at the time point t₁ in which the level is not more than the reference value S_{RFd}, as shown in (e), the microcomputer 161 switches the actuator control of the objective lens 5 from the focus control state to the lens saving state, namely, the state in which a direct current lens-pull voltage is applied. The rotation speed of the optical disc 2 in (f) is gradually reduced after the time point tₛ due to the drive stop of the disc motor 3, as well as due to the application of the brake force. The rate of the reduction is greater than the case of FIG. 3 (f) in the first embodiment. After the time point tₛ, the tray position is moved to the position in which the outer peripheral side face of the optical disc 2 comes into contact with the brake pad. The outer peripheral side face comes into contact with the brake pad at the time point t₂. After the time point t₂, the rotation speed n of the optical disc 2 is rapidly reduced to zero by friction of the brake pad. The rotation speed n of the optical disc 2 is detected by the rotation speed detector 14, and is compared with the reference value (rotation speed detection threshold level) n_{d} ((f)). As a result of the comparison, when the rotation speed n is not more than the reference value n_{d}, the output of the second signal Sᵣ from the rotation speed detector 14 is turned on at the time point t_{E} (after the time point t₂) in which the rotation speed n is not more than the reference value n_{d}. As a result, the second signal Sᵣ and the first signal S₁ output from the emergency detector 15 are input to the logical circuit unit 18. In response to this input, the logical circuit unit 18 produces and outputs the third signal Sₜ. The third signal Sₜ controls the switch SW3 at the time point t_{E} to cause the control signal (mute signal) S₃ to be supplied from the ground to the actuator controller 12. Based on the control signal (mute signal) S₃, the actuator controller 12 stops the actuator control and releases the saving state of the objective lens 5 ((e)). The time between the time points t₂ and t_{E} in FIG. 6 is reduced shorter than the time between the time points t₂ and t_{E} in FIG. 3.

FIG. 7 is a flowchart of the emergency eject operation in the optical disc apparatus in FIG. 5.

As shown in FIG. 7, the following steps are performed:

(1) During the recording or reproduction of information on the optical disc 2, the switch SW1 is turned off (to the open state) by manual operation of the user, and the emergency eject operation is started (Step S701).

(2) As the switch SW1 is turned off, the emergency eject detector 15 performs the detection of an emergency eject operation instruction. The microcomputer 161 of the DSP 16 determines whether this was performed, namely, whether the first signal S₁ was output from the emergency eject detector 15 (Step S702).

(3) As a result of the determination, when the first signal S₁ has been output from the emergency eject detector 15, the first signal S₁ is input to the switch SW2. Based on the first signal S₁, the connection state of the switch SW2 is switched to turn off the supply of the enable signal S₂ from the DSP 16 to the laser controller 13. Also the first signal S₁ is input to the switch SW4. Based on the first signal S₁, the connection state of the switch SW4 is switched to turn on the supply of the control signal S₄ for instructing the drive stop of the disc motor 3 and the generation of a brake force, from the ground to the motor controller 11 (Step S703).

(4) As the supply of the enable signal S₂ to the laser controller 13 is stopped, the laser drive circuit 131 stops the drive of the laser diode 6. Thus the laser output is turned off (the light is turned off) (Step S704).

(5) As the laser output is turned off, the level of the RF signal S_{RF} from the reflected laser beam is gradually reduced to zero. The microcomputer 161 determines whether the level of the RF signal S_{RF}, which is input to the DSP 16 through the AFE 17, is not more than the predetermined reference value (S_{RFd} shown in FIG. 3 (d)) (Step S705).

(6) As a result of the determination in Step S705, when the level of the RF signal S_{RF} is not more than the predetermined reference value, the microcomputer 161 causes the DSP 16 to produce therein the control signal for instructing the actuator controller 12 to perform the actuator control to make the objective lens 5 in the saving state. The control signal is input from the DSP 16 to the actuator controller 12. Based on the control signal, the actuator controller 12 performs the actuator control, namely, the actuator controller 12 controls the actuator to save and move the objective lens 5 (as lens-pull operation) (Step S706). After the saving movement, the objective lens 5 is moved to a position in which the end portion or protector thereof is separated from the disc surface of the optical disc 2 by a distance greater than the amount of surface deflection of the optical disc 2.

(7) When the disc motor 3 is stopped and the brake force is applied, the rotation speed of the disc motor 3 is gradually reduced and the rotation speed of the optical disc 2 is also reduced. The optical disc 2 in such a rotation state is ejected and moved by the tray, and the outer peripheral side face thereof is brought into contact with the brake pad 50. The rotation speed of the optical disc 2 is rapidly reduced by friction of the contact, and finally the rotation is stopped. In the ejection movement of the optical disc 2, the objective lens 5 is already located in the saving position by the actuator control. For this reason, the objective lens 5 does not come into contact with the disc surface of the optical disc 2. The rotation speed detector 14 detects the rotation speed of the optical disc 2 in such a state (rotation reduced state after the contact with the brake pad 50) or the rotation speed of the disc motor 3, and determines whether the rotation speed is not more than the predetermined reference value (n_{d} in FIG. 3(f)) (Step S707).

(8) As a result of the determination in Step S707, when the rotation speed of the optical disc 2 or disc motor 3 is not more than the predetermined reference value, the rotation speed detector 14 outputs the second signal Sᵣ. As a result, the second signal Sᵣ and the first signal S₁ are input to the logical circuit unit 18. In response to this input, the logical circuit unit 18 produces and outputs the third signal Sₜ. The third signal Sₜ switches the connection state of the switch SW3 to cause the control signal for instructing the stop of the actuator control, namely, the control signal (mute signal) S₃ for instructing the release of the saving state of the objective lens 5, to be supplied from the ground to the actuator controller 12. Based on the control signal (mute signal) S₃, the actuator controller 12 stops the actuator control and releases the saving state of the objective lens 5 (as lens-pull release operation) (Step S708).

(9) As a result of the determination in Step S707, when the rotation speed of the optical disc 2 or disc motor 3 exceeds the predetermined reference value, the actuator control is not stopped and the saving state of the objective lens 5 is maintained.

(10) After the release of the saving state of the objective lens 5 in Step S708, the optical disc 2 in the rotation stop state is ejected and moved outside the apparatus together with the tray by manual operation of the user, and then the emergency eject operation ends (Step S709).

According to the above described second embodiment, in the emergency eject operation in the optical disc apparatus, the objective lens is also made in the saving state until the rotation of the optical disc is stopped or nearly stopped. For this reason, the objective lens or the protector thereof does not come into contact with the disc surface even if the surface of the optical disc 2 is deflected. This makes it possible to eliminate scratches on the disc surface. Particularly, in the second embodiment, the brake force is additionally applied to the disc motor 3 in the emergency eject operation, so that the optical disc 2 comes into contact with the brake pad 50 in a state in which the rotation is substantially reduced. For this reason, the friction noise of the brake pad 50 is low. Further, it is possible to reduce the time until the saving state of the objective lens 5 is released after the optical disc 2 comes into contact with the brake pad 50. This makes it possible to reduce the time necessary for the entire emergency eject operation.

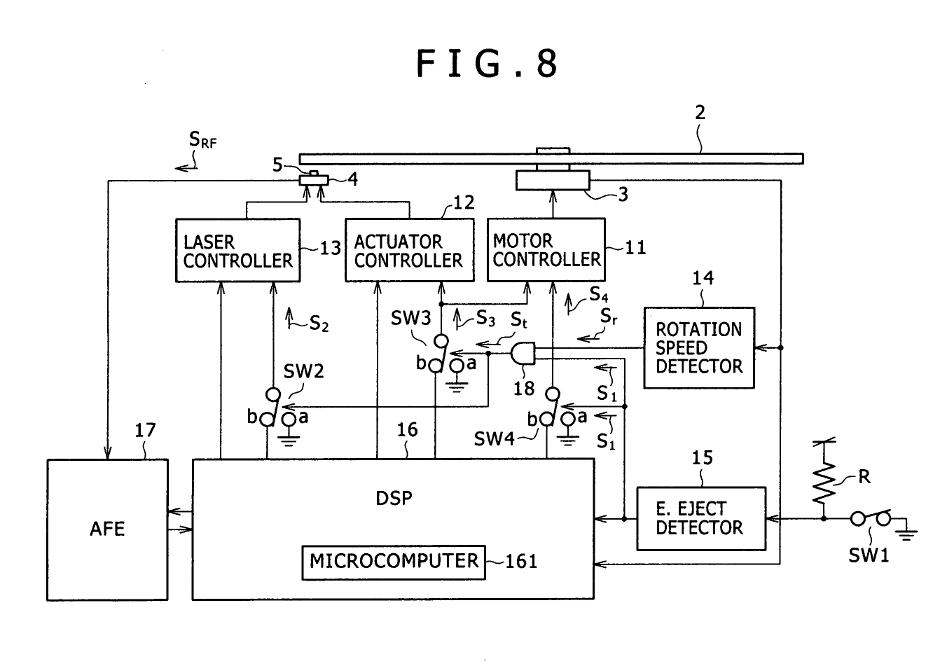

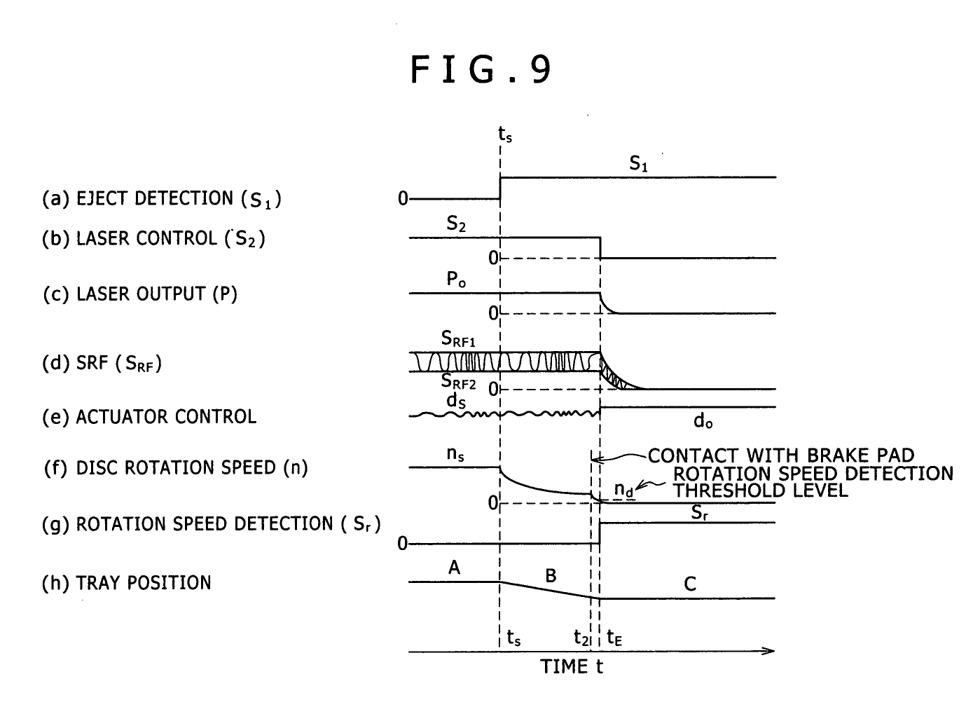

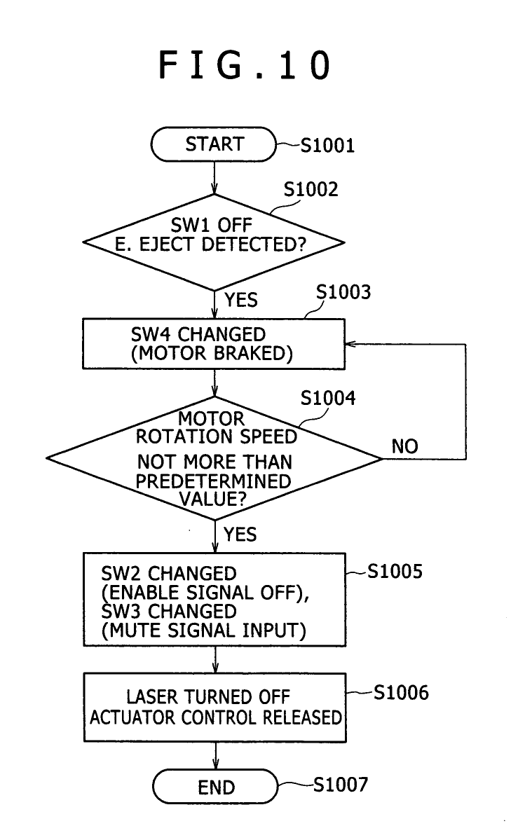

FIGS. 8 to 10 are diagrams of a third embodiment of the present invention. FIG. 8 is a block diagram of an optical disc apparatus as a third embodiment of the present invention. FIG. 9 is a diagram showing the operation states of the respective units in an emergency eject operation in the optical disc apparatus in FIG. 8. FIG. 10 is a flowchart of the emergency eject operation in the optical disc apparatus in FIG. 8. The third embodiment exemplifies the case in which, in the emergency eject operation, the objective lens is maintained in the focus control state without being made in the saving state as the actuator control, while the rotation speed of the optical disc is reduced by applying a brake force to the disc motor similarly to the case of the second embodiment, and the focus control state is released when the rotation speed of the optical disc is sufficiently reduced by friction of the brake pad.

The optical disc apparatus in FIG. 8 has a different signal for controlling the switch SW2, compared to the case of the optical disc apparatus in FIG. 5. That is, in the emergency eject operation, the optical disc apparatus performs the actuator control without turning off the laser output, and performs the focus control of the objective lens as the actuator control.

In the configuration in FIG. 8, when the user performs an emergency eject operation during when the optical disc apparatus records or reproduces information on the optical disc 2, the switch SW1 is turned off (to the open state). The emergency eject detector 15 performs the detection of an emergency eject operation instruction, and outputs the first signal S₁. The first signal S₁ is input to the switch SW4, the logical circuit unit 18, and the DSP 16. The on/off state of the switch SW4 is controlled based on the first output signal S₁. In the switch SW4, the connection to the terminal b side is turned on (to the closed state) to cause the control signal S₄ for instructing the drive stop of the disc motor 3 and the application of a brake force, to be supplied from the ground to the motor controller 11. The switches SW2, SW3 are controlled by the third signal Sₜ output from the logical circuit unit 18.

As the drive of the disc motor 3 is stopped, the rotation speed of the optical disc 2 or the rotation speed of the disc motor 3 is gradually reduced. In addition, as the brake force is applied, the reduction of the rotation speed of the disc motor 3 is accelerated. When the user performs the emergency eject operation, the optical disc 2 is moved in the direction of being ejected from the apparatus together with the tray, while the rotation speed is reduced. The rotation speed is rapidly reduced in the position in which the outer peripheral side face of the optical disc 2 comes into contact with the brake pad 50, and finally the rotation is stopped. During the movement of the optical disc 2, the laser output is still not turned off. Thus the objective lens 5 is in the focus control state by the actuator control. For this reason, the objective lens 5 does not come into contact with the disc surface of the optical disc 2 which is still rotating although the rotation speed is reduced. The rotation speed detector 14 detects the rotation speed of the optical disc 2 in such a state or the rotation speed of the disc motor 3, and compares the detected rotation speed with a predetermined reference value. As a result of the comparison, when the detected rotation speed exceeds the reference value, the rotation speed detector 14 does not output the second signal Sᵣ. On the other hand, when the rotation speed of the optical disc 2 or the disc motor 3 is not more than the reference value as a result of the comparison, the rotation speed detector 14 outputs the second signal Sᵣ. The second signal Sᵣ is input to the logical circuit unit 18, similarly to the first signal S₁ output from the emergency eject detector 15.

The logical circuit unit 18 produces and outputs the third signal Sₜ based on the first signal S₁ and on the second signal Sᵣ. In other words, the logical circuit unit 18 does not produce (does not output) the third signal Sₜ when the second signal Sᵣ is not output from the rotation speed detector 14, namely, the second signal Sᵣ is not input to the logical circuit unit 18 and only the first signal S₁ is input thereto. On the other hand, the logical circuit unit 18 produces and outputs the third signal Sₜ when the second signal Sᵣ is output from the rotation speed detector 14 and is input to the logical circuit unit 18 together with the first signal S₁. The third signal Sₜ controls the switches SW2 and SW3. More specifically, in the switch SW2, the third signal Sₜ turns on the connection to the terminal a side (to the closed state) in the switch SW2, to stop the supply of the enable signal S₂ from the DSP 16 to the laser controller 13. In this way, the laser drive circuit 131 stops the drive of the laser diode 6 to turn off the laser output. In the signal SW3, the third signal Sₜ turns on the connection to the terminal a side (to the closed state) and turns off the connection to the terminal b side (to the open state), to cause the control signal for instructing the stop of the actuator control, namely, the control signal (mute signal) S₃ for instructing the release of the focus control state of the objective lens 5, to be supplied from the ground to the actuator controller 12. Based on the control signal (mute signal) S₃, the actuator controller 12 stops the actuator control and releases the focus control state of the objective lens 5. At this time, the optical disc 2 has been almost in a rotation stop state. Thus, there could be no scratch occurring on the disc surface, even if the focus control state of the objective lens 5 is released and the end portion or protector of the objective lens 5 comes into contact with the disc surface of the optical disc 2. After the rotation is stopped, the optical disc 2 is ejected and moved outside the apparatus together with the tray by manual operation of the user.

FIG. 9 is a diagram showing the operation states of the respective units in the emergency eject operation in the optical disc apparatus in FIG. 8. The abscissa is a time axis.

In FIG. 9, (a) shows the level change state of the first signal S₁ output from the emergency eject detector 15, when the user performs an emergency eject operation and the switch SW1 is turned off (to the open state) at the time point tₛ; (b) shows the level change state of the enable signal S₂ supplied from the DSP 16 to the laser controller 13; (c) shows the level change state of the laser beam (laser output) P output from the laser diode 6; (d) shows the change state of the RF signal S_{RF}; (e) shows the change state of the focus direction position of the objective lens 5 by the actuator control; (f) shows the change state of the rotation speed n of the optical disc 2; (g) shows the change state of the second signal Sᵣ output by the rotation speed detector 14; and (h) shows the change state of the tray position, respectively.

At the time point tₛ in which the switch SW1 is turned off (to the open state) and the first signal S₁ is output from the emergency eject detector 15, the enable signal S₂ is still not turned off, so that the focus control state as the actuator control is not released in the objective lens 5. Subsequently, the rotation speed of the optical disc 2 continues to be reduced, and then the second signal Sᵣ is output from the rotation speed detector 14. As a result, the third signal Sₜ is output from the logical circuit unit 18. The objective lens 5 remains in the focus control state until the time point t_{E} in which the enable signal S₂ is turned off by the switch SW2. In the focus control state, the RF signal S_{RF} is in a steady-state level range with the maximum value S_{RF1} and the minimum value S_{RF2}. The rotation speed of the optical disc 2 in (f) is gradually reduced due to the drive stop of the disc motor 3, as well as due to the application of the brake force. The rate of the reduction is greater than the case of FIG. 3(f) in the first embodiment, similarly to the case of FIG. 6(f) in the second embodiment. After the time point tₛ, the tray position is moved to the position in which the outer peripheral side face of the optical disc 2 comes into contact with the brake pad. The outer peripheral side face comes into contact with the brake pad at the time point t₂. After the time point t₂, the rotation speed n of the optical disc 2 is rapidly reduced to zero by friction of the brake pad. The rotation speed n of the optical disc 2 is detected by the rotation speed detector 14, and is compared with the reference value (rotation speed detection threshold level) n_{d} ((f)) in the rotation speed detector 14. As a result of the comparison, when the rotation speed n is not more than the reference value n_{d}, the output of the second signal Sᵣ from the rotation speed detector 14 is turned on at the time point t_{E} (after the time point t₂) in which the rotation speed n is not more than the reference value n_{d}. As a result, the second signal Sᵣ and the first signal S₁ output from the emergency eject detector 15 are input to the logical circuit unit 18. In response to this input, the logical circuit unit 18 produces and outputs the third signal Sₜ. The third signal Sₜ controls the switches SW2 and SW3 at the time point t_{E} to stop the supply of the enable signal S₂ from the DEP 16 to the laser controller 13, while causing the control signal (mute signal) S₃ to be supplied from the ground to the actuator controller 12. Based on the control signal (mute signal) S₃, the actuator controller 12 stops the actuator control and releases the focus control state of the objective lens 5 ((e)). Further, the time between the time points t₂ and t_{E} in FIG. 9 is reduced shorter than the time between the time points t₂ and t_{E} in FIG. 3.

FIG. 10 is a flowchart of the emergency eject operation in the optical disc apparatus in FIG. 8.

As shown in FIG. 10, the following steps are performed:

(1) During the recording or reproduction of information on the optical disc 2, the switch SW1 is turned off (to the open state) by manual operation of the user, and the emergency eject operation is started (Step S1001).

(2) As the switch SW1 is turned off, the emergency eject detector 15 performs the detection of an emergency eject operation instruction. The microcomputer 161 of the DSP 16 determines whether this was performed, namely, whether the first signal S₁ was output from the emergency eject detector 15 (Step S1002).

(3) As a result of the determination, when the first signal S₁ has been output, the first signal S₁ is input to the switch SW4. Based on the first signal S₁, the connection state of the switch SW4 is switched to turn on the supply of the control signal S₄ for instructing the drive stop of the disc motor 3 and the generation of a brake force, from the ground to the motor controller 11 (Step S1003).

(4) When the drive of the disc motor 3 is stopped and the brake force is applied, the rotation speed of the disc motor 3 is gradually reduced and the rotation speed of the optical disc 2 is also reduced. The optical disc 2 in such a rotation state is ejected and moved by the tray, and the outer peripheral side face thereof is brought into contact with the brake pad 50. The rotation speed of the optical disc 2 is rapidly reduced by friction of the contact, and finally the rotation is stopped. During the ejection movement of the optical disc 2, the object lens 5 is still in the focus control state by the actuator control. For this reason, the object lens 5 does not come into contact with the disc surface of the optical disc 2. The rotation speed detector 14 detects the rotation speed of the optical disc 2 in such a state (the rotation speed reduced state after the contact with the brake pad 50) or the rotation speed of the disc motor 3, and determines whether the rotation speed is not more than the predetermined reference value (n_{d} in FIG. 9 (f)) (Step S1004).

(5) As a result of the determination in Step S1004, when the rotation speed of the optical disc 2 or disc motor 3 is not more than the predetermined reference value, the rotation speed detector 14 outputs the second signal Sᵣ. As a result, the second signal Sᵣ and the first signal S₁ are input to the logical circuit unit 18. In response to this input, the logical circuit unit 18 produces and outputs the third signal Sₜ. The third signal Sₜ switches the connection states of the switches SW2 and SW3 (Step S1005).

(6) The connection state of the SW2 is switched so as to stop the supply of the enable signal S₂ to the laser controller 13. In this way, the laser drive circuit 131 stops the drive of the laser diode 6, and the laser output is turned off (the light is turned off) (FIG. 9 (c)). The connection state of the switch SW3 is switched so as to cause the control signal for instructing the stop of the actuator control, namely, the control signal (mute signal) S₃ for instructing the release of the focus control state of the objective lens 5, to be supplied from the ground to the actuator controller 12. Based on the control signal (mute signal) S₃, the actuator controller 12 stops the actuator control and releases the focus state of the objective lens 5 (FIG. 9 ((e)) (Step S1006). The laser output is turned off, so that the level of the RF signal S_{RF} is gradually reduced to zero (FIG. 9((d)).

(7) As a result of the determination in Step S1004, when the rotation speed of the optical disc 2 or disc motor 3 exceeds the predetermined reference value, the rotation speed detector 14 does not output the second signal Sᵣ. As a result, the first signal Sₜ and the second signal Sᵣ are input to the logical circuit unit 18. In response to this input, the logical circuit unit 18 does not produce the third signal Sₜ. As the third signal Sₜ is not output from the logical circuit unit 18, the connection states of the switches SW2 and SW3 are not switched. In this case, it waits until the rotation speed of the disc motor 3 is reduced.

(8) After the focus control state of the objective lens 5 is released in Step S1006, the optical disc 2 in the rotation stop state, is ejected and moved outside the apparatus together with the tray by manual operation of the user, and then the emergency eject operation ends (Step S1007).

According to the above described third embodiment, in the emergency eject operation in the optical disc apparatus, the focus control state of the objective lens is maintained until the rotation of the optical disc is stopped or nearly stopped. For this reason, the objective lens or the protector thereof does not come into contact with the disc surface even if the surface of the optical disc 2 is deflected. Thus, also in the third embodiment, it is possible to eliminate scratches on the disc surface. In the third embodiment, similarly to the case of the second embodiment, the brake force is additionally applied to the disc motor 3 in the emergency eject operation, so that the optical disc 2 comes into contact with the brake pad 50 in a state in which the rotation of the optical disc 2 is substantially reduced. For this reason, the friction noise of the brake pad 50 is low. Further, it is possible to reduce the time until the focus control state is released after the optical disc 2 comes into contact with the brake pad 50. This makes it possible to reduce the time necessary for the entire emergency eject operation.

Incidentally, in each of the above described embodiments, the rotation speed detector 14 is configured to output the second signal Sᵣ when the detected rotation speed of the optical disc 2 or disc motor 3 is not more than the predetermined reference value as a result of the determination, and not to output the second signal Sᵣ when the detected rotation speed exceeds the predetermined reference value. However it may be configured inversely. That is, the rotation speed detector 14 does not output the second signal Sᵣ when the detected rotation speed of the optical disc 2 or disc motor 3 is not more than the predetermined reference value as a result of the determination, and outputs the second signal Sᵣ when the detected rotation speed exceeds the predetermined reference value. Further, in line with this, the logical circuit unit 18 may be configured to produce and output the third signal Sₜ when the second signal Sᵣ is not input and only the first signal S₁ is input, and not to produce the third signal Sₜ when the first signal S₁ and the second signal Sᵣ are input. Further, in each of the above described embodiments, the microcomputer is included in the DSP as the controller. However the microcomputer may be provided outside the DSP. Further, in each of the above described embodiments, the comparison with the reference value (the rotation speed detection threshold level) is performed in the rotation speed detector. However, the comparison may be performed in the DSP as the controller or in the microcomputer.

As described above, it is possible for the optical disc apparatus to prevent the objective lens or the protector thereof from coming into contact with the disc surface in the emergency eject operation, thereby making it possible to avoid scratches on the disc surface.

The present invention can be applied to other embodiments without departing from the sprit or essential characteristics thereof. Thus the above described embodiments are merely illustrative examples in all respects and should not be construed as being restrictive. The scope of the present invention is defined by the appended claims. Further, all changes and modifications belonging to the scope equivalent to the claims are included within the scope of the present invention.

What is claimed is:

1. An optical disc apparatus capable of performing an emergency eject operation of an optical disc, comprising:
a disc motor for rotating and driving said optical disc;
a motor controller for controlling a rotation state of said disc motor;
a laser diode for generating a laser beam;
a laser controller for controlling the drive of said laser diode;
an objective lens for focusing the laser beam output from said laser diode, and irradiating the laser beam on said optical disc;
an actuator for driving said objective lens to change the position and posture of the objective lens;
an actuator controller for controlling said actuator to make said objective lens in a focus control state or in a saving state in which the objective lens is separated from a disc surface;
a controller for producing and outputting a control signal for controlling said motor controller, said laser controller, and said actuator controller, respectively;
an emergency eject detector for detecting that said emergency eject operation is instructed;
a rotation speed detector for procuring and outputting a signal corresponding to the rotation speed of said optical disc or to the rotation speed of said disc motor; and
a logical circuit unit that is based on a first output signal output from said emergency eject detector as well as on a second output signal output from said rotation speed detector, and when the second output signal is not more than a reference value, the logical circuit unit producing and outputting a third output signal to cause a control signal for instructing the stop of said actuator control, to be supplied from said controller to said actuator controller,
wherein, after detection of the emergency eject operation instruction, the optical disc apparatus performs said actuator control to make said objective lens in said focus control state or in said saving state, until the rotation speed of said optical disc is not more than a predetermined value.

2. The optical disc apparatus according to claim 1,
wherein said controller determines the level of an RF signal from the reflected laser beam from said optical disc, and when the level is not more than the reference value, produces a control signal for instructing said actuator controller to perform the actuator control to make said objective lens in said saving state.

3. The optical disc apparatus according to claim 1,
wherein said emergency eject detector produces and outputs said first output signal by the operation of an emergency eject operation instruction switch, and
the optical disc apparatus is configured, based on the first output signal, to turn off the supply of a control signal for turning on the laser output of said laser diode, from said controller to said laser controller.

4. The optical disc apparatus according to claim 2,
wherein said emergency eject detector produces and outputs said first output signal by the operation of an emergency eject operation instruction switch, and
the optical disc apparatus is configured, based on the first output signal, to turn off the supply of a control signal for turning on the laser output of said laser diode, from said controller to said laser controller.

5. The optical disc apparatus according claim 1,
wherein said emergency eject detector produces and outputs said first output signal by the operation of an emergency eject operation instruction switch, and
the optical disc apparatus is configured, based on the first output signal, to turn off the supply of a control signal for turning on the laser output of said laser diode, from said controller to said laser controller, as well as to turn on the supply of a control signal for instructing the application of a brake force to said disc motor, from said controller to said motor controller.

6. The optical disc apparatus according to claim 2,
wherein said emergency eject detector produces and outputs said first output signal by the operation of an emergency eject operation instruction switch, and
the optical disc apparatus is configured, based on the first output signal, to turn off the supply of a control signal for tuning on the laser output of said laser diode, from said controller to said laser controller, as well as to turn on said supply of a control signal for instructing the application of a brake force to said disc motor, from said controller to said motor controller.

7. The optical disc apparatus according to claim 1,
wherein, when the rotation speed of said optical disc is not more than the predetermined value in the emergency eject operation, said logical circuit unit produces and outputs a signal for turning off the supply of a control signal for turning on the laser output of said laser diode, from said controller to said laser controller, based on said first output signal.

8. The optical disc apparatus according to claim 7,
wherein said emergency eject detector produces and outputs said first output signal by the operation of an emergency eject operation instruction switch, and
the optical disc apparatus is configured, based on said first output signal, to turn on the supply of a control signal for instructing the application of a brake force to said disc motor, from said controller to said motor controller.

9. The optical disc apparatus according to claim 1,
wherein said emergency eject detector produces and outputs said first output signal by the operation of an emergency eject operation instruction switch, and
the optical disc apparatus is configured, based on said first output signal, to turn on the supply of a control signal for instructing the application of a brake force to said disc motor, from said controller to said motor controller.

10. The optical disc apparatus according to claim 2,
wherein said emergency eject detector produces and outputs said first output signal by the operation of an emergency eject operation instruction switch, and
the optical disc apparatus is configured, based on said first output signal, to turn on the supply of a control signal for instructing the application of a brake force to said disc motor, from said controller to said motor controller.

11. The optical disc apparatus according to claim 1, further comprising a switch between said controller and said actuator controller to turn on/off the supply of a control signal for instructing the stop of said actuator control, from said controller to said actuator controller,
wherein the switch is configured to be operated and turned on/off based on said signal output from said logical circuit unit.

12. The optical disc apparatus according to claim 2, further comprising a switch between said controller and said actuator controller to turn on/off the supply of a control signal for instructing the stop of said actuator control, from said controller to said actuator controller,
wherein the switch is configured to be operated and turned on/off based on said signal output from said logical circuit unit.

13. The optical disc apparatus according to claim 11, further comprising a switch between said controller and said laser controller to turn on/off the supply of a control signal for turning on the laser output of said laser diode, from said controller to said laser controller,
wherein the switch is configured to be operated based on said first output signal output from said emergency eject detector, thereby to turn off said supply of said control signal.

14. The optical disc apparatus according to claim 12, further comprising a switch between said controller and said laser controller to turn on/off the supply of a control signal for turning on the laser output of said laser diode, from said controller to said laser controller,
wherein the switch is configured to be operated based on said first output signal output from said emergency eject detector, thereby to turn off said supply of said control signal.

15. The optical disc apparatus according to claim 11, further comprising a switch between said controller and said motor controller to turn on/off the supply of a control signal for instructing the application of a brake force to said disc motor, from said controller to said motor controller,
wherein the switch is configured to be operated based on said first output signal output from said emergency eject detector, thereby to turn on said supply of said control signal.

16. The optical disc apparatus according to claim 13,
further comprising a switch between said controller and said motor controller to turn on/off the supply of a control signal for instructing the application of a brake force to said disc motor, from said controller to said motor controller,
wherein the switch is configured to be operated based on said first output signal output from said emergency eject detector, thereby to turn on said supply of said control signal.

17. The optical disc apparatus according to claim 11, further comprising a switch between said controller and said laser controller to turn on/off the supply of a control signal for turning on the laser output of said laser diode, from said controller to said laser controller,
wherein the switch is configured to be turned on/off based on said signal output from said logical circuit unit.

18. The optical disc apparatus according to claim 11, further comprising a switch between said controller and said motor controller to turn on/off the supply of a control signal for instructing the application of a brake force to said disc motor, from said controller to said motor controller,
wherein the switch is configured to be operated based on said first output signal output from said emergency eject detector, thereby to turn on the supply of said control signal to the motor controller.
